(19) United States
(12) Patent Application Publication
(10) Pub. No.: US 2026/0103297 A1
(43) Pub. Date: Apr. 16, 2026

(54) Automatic Vane Controller for Solar Sail

(71) Applicant: L'Garde, Inc., Tustin, CA (US)

(72) Inventors: Arthur L. Palisoc, Tustin, CA (US); Steven C. Widelitz, Riverside, CA (US)

(21) Appl. No.: 19/356,490

(22) Filed: Oct. 13, 2025

Related U.S. Application Data
(60) Provisional application No. 63/706,164, filed on Oct. 11, 2024.

(51) Int. Cl. B64G 1/24; B64G 1/40; F03G 7/06

(52) U.S. Cl. CPC B64G 1/244; B64G 1/407; F03G 7/06145

(57) ABSTRACT

Systems and methods described herein include control systems and methods for solar sails. Control systems may include shape memory structures configured to position a solar vane when the shape memory structure changes temperature to a transition temperature. The control system may optionally include a biasing element in order to define the position and/or control of the solar vane during the movement of the vane when the shape memory structure is in the transition temperature.

### PRIORITY

The present application claims priority to US Provisional Application number 63/706,164, filed Oct. 11, 2024, incorporated by reference in its entirety herein.

### BACKGROUND

Solar sails are a device used for spacecraft propulsion that uses solar radiation pressure to propel a sail in space, much in the same way the wind propels sails on sailboats. For a sailboat, air molecules push on the sail fabric. For solar sails, photons bombard a solar sail in space and push against a material that has a reflective surface resulting in a transfer of momentum from the photon to the sail. The most commonly used source of photons in solar sail applications is the sun, but other sources of light, such as lasers, can also propel reflective sails.

Several solar sails have been designed in past years, and a few very basic sails have been launched into space. Typically, a solar sail has the primary objective of increasing surface area of the material to increase the momentum transfer from photons to the sail. However, because payloads are limited in size and wight, the solar sail can be compactable into a storage configuration. The overall size and weight of the storage configuration is desirably minimized.

Sails may include motors and/or other controllers to move the sails and control the direction of the sail propulsion. However, adding additional components increases the storage weight and size of the sail.

Exemplary solar sail designs by Applicant are shown and described in in U.S. Pat. No. 11,142,348, issued Oct. 12, 2021, titled “Solar Sail for Orbital Maneuvers”, and International Patent Publication WO 2020/223733, published Nov. 5, 2020, titled Solar Sail Attachment and Deployment Methods, each of which are incorporated in their entirety herein.

Vane sails may have many different space applications. For example, solar vanes may be used as sails as a propulsion method to propel craft in space. The propulsion methods may be used to accelerate and/or decelerate the object or vessel coupled to the vane sails. Many vanes require active activation and control of the vanes in order to apply the desired propulsion for acceleration or deceleration according to the desired application. However, such control adds additional components to the system that increases complexity, weight, and cost.

### SUMMARY

Systems and methods described herein include control systems and methods for solar sails. Control systems may include shape memory structures configured to position a solar vane when the shape memory structure changes temperature to a transition temperature. The control system may optionally include a biasing element in order to define the position and/or control of the solar vane during the movement of the vane when the shape memory structure is at or past the transition temperature.

Exemplary embodiments described herein include solar sails comprising one or more vanes that include automatic controllers having shape memory components that are actuated automatically when the temperature reaches or passes (whether above or below) a transition temperature of a memory material of the shape memory component.

A solar sail structure is shown and described herein having one or more vanes; a first controller; and a second controller, wherein the first controller and second controller are configured to rotate a vane of the one or more vanes to position the vane in a first orientation or a second orientation.

The first and/or second controller may comprise a shape memory material.

The shape memory material may be a one way shape memory material or a two way shape memory material. The one way shape memory material is configured to transition in one way when the material reaches or passes the transition temperature. In order to restore the material to its original position, a load must be applied to the material. The two way shape memory material is configured to transition in two ways, in a first direction and an opposite direction so that the material transitions between two states depending on the temperature of the material and where the temperature is relative to one or more transition temperatures.

The first and/or second controller may comprise one, two, or more biasing elements. In an optional configuration, the biasing element may be a spring. The biasing element may be other components and is not limited to a spring. The biasing element may be, for example, a coil spring, tension element, compressible element, elastic material, etc.

The biasing element may or may not include a shape memory material.

The first and/or second controller may not include a shape memory material.

The first and/or second controller may comprise a passive biasing element. As described herein, the biasing element may be a spring, such as, for example, coil spring, tension element, compressible element, elastic material, etc.

The passive biasing element may not include a shape memory material or other active mode of moving the element. Instead, the passive biasing element may be configured to return to a primary configuration and is maintained in a configuration different from the primary configuration through application of an outside force that imposes the biasing force.

The shape memory material shown and described herein may comprise a remembered configuration in which the shape memory material is out of the remembered configuration and is configured to return to the remembered configuration when the material reaches a temperature that is at or past a transition temperature.

In an exemplary configuration, the remembered configuration comprises a shortened spring length. Shortened is intended to be a relative term of the spring length as compared to the initial configuration of the spring so that once the shape memory material reaches or surpasses the transition temperature of the shape memory material, the spring shortens.

In an exemplary configuration, the remembered configuration comprises a lengthened spring length. Lengthened is intended to be a relative term of the spring length as compared to the initial configuration of the spring so that once the shape memory material reaches or surpasses the transition temperature of the shape memory material, the spring elongates.

The solar sail structure may also include one or more temperature enclosures and/or temperature sources around any one or more of the controllers.

A method of passively controlling a solar sail is also provided herein. The method may include providing a solar sail having one or more controllers with a shape memory material for passively controlling the solar sail. The solar sail may be deployed in an orbit, and the one or more controllers transition the position of one or more vanes coupled to the one or more controllers depending on a position of the solar sail in the orbit because of the temperature experienced by the one or more controllers from its position in the orbit.

The method may also include the one or more controllers transitioning the one or more vanes associated with the one or more controllers from a first position when the solar sail is in one portion of the orbit to a second position when the solar sail is in a second portion of the orbit.

The method may also include the one or more controllers transitioning the one or more vanes associated with the one or more controllers from the second position to the first position when the solar sail reenters the first portion of the orbit.

### DRAWINGS

FIG. 1 illustrates exemplary embodiments of a solar sail described herein.

FIG. 2 illustrates an exemplary method of using the solar sail according to embodiments described herein.

FIGS. 3A-3C illustrate exemplary configurations of the solar sail during deployment according to embodiments described herein. FIG. 3A is the solar sail in a stored configuration.

FIG. 3B is the solar sail in an open configuration. FIG. 3C is the solar sail in a deployed configuration.

FIGS. 3D and 3E illustrate exemplary control configurations of an individual sail according to embodiments described herein. FIG. 3D is an illustration of the control system in a first configuration and FIG. 3E is an illustration of the control system in a second configuration.

FIGS. 4A-4C illustrate exemplary blown-up component parts of exemplary features of the solar sail according to embodiments described herein. FIG. 4A is a partial component view of the control system from a first perspective. FIG. 4B is the partial component view of FIG. 4A from a second perspective. FIG. 4C is the partial component view of FIG. 4A from a third perspective.

FIGS. 5A-5B illustrate exemplary configurations of the solar sail to illustrate the movement of the sail according to embodiments described herein. FIG. 5A illustrates the exemplary configuration from a top view. FIG. 5B illustrates the exemplary configuration from a representative side view showing orientation only and not necessarily the depth of component parts.

FIGS. 6A-6B illustrate exemplary configurations of the solar sail to illustrate the movement of the sail according to embodiments described herein.

FIG. 7 illustrates an exemplary motion of the solar sail about the earth and the movement of the vanes using the one or more controllers described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein include solar sails comprising one or more vanes that include automatic controllers having shape memory components that are actuated automatically when the temperature reaches or passes (whether above or below) a transition temperature of a memory material of the shape memory component.

Systems and methods described herein include control systems and methods for solar sails. Control systems may include shape memory structures configured to position a solar vane when the shape memory structure changes temperature to a transition temperature. The control system may optionally include a biasing element in order to define the position and/or control of the solar vane during the movement of the vane when the shape memory structure is in the transition temperature.

Although embodiments of the invention may be described and illustrated herein in terms of specific solar sail configurations, it should be understood that embodiments of this invention are not so limited but are additionally applicable to different sail configurations configurations. For example, although four sails are disclosed, additional sails may be used. Sails may also be coupled together so that a sail may have more than one sail part with connections therebetween. The connections may include embodiments and configurations as described herein to provide different mobility and configurations of the sails. In addition, the use of the term solar sail is not intended to be limiting in the use of the energy source to propel the sail. Solar sail is intended to include vanes that are used by solar energy, but which may use other energy sources in a space environment. In addition, the use of the term solar sail is not intended to be limiting in the use of the vane as a propulsion device. It may also be used as a drag sail such as in deorbit applications. It may also be used in other configurations for controlling the acceleration and/or deceleration of the vane and resulting solar sail.

Exemplary embodiments described herein include collapsible sail structures for a deployable sail. Exemplary embodiments may use different sail materials and/or structures to create different collapsible sails. For example, sail supports may be telescoping booms, deformable or shape memory material structures, etc. Exemplary structures may be found in the references incorporated herein by reference.

Exemplary embodiments described herein comprise means for creating a controller for positioning an orientation of the sail according to embodiments described herein. Exemplary controllers may include shape memory structures that are configured to reorient or change position and/or shape based on heat or light received during the trajectory or sail path of the sail.

As shown and described herein, a specific shape memory structure comprises one or more shape memory springs that may be used with out or with one or more biasing elements. The combination of the shape memory spring(s) with or without the biasing element(s) may be used to automatically move one or more of the vanes to a desired orientation during the sail path.

Any feature, component, configuration, and/or attribute described for any one example may be used in combination with any other example. Accordingly, any step, feature, component, configuration, and/or attribute may be used in any combination and remain within the scope of the instant description. Features may be removed, added, duplicated, integrated, subdivided, or otherwise recombined and remain within the scope of the instant disclosure. The exemplary embodiments described herein are provided for sake of example only.

Exemplary embodiments of the controller may be used with a passively articulating de-orbiter based on a shape memory alloy (SMA) spring-counter spring (SCS). Exemplary embodiments may be used in higher lower-earth-orbit (LEO).

Exemplary embodiments of the controller shown and described herein may make use of a shape memory material that has a remembered configuration at a temperature band. The vane sails of the de-orbiter are therefore configured with the controller to open up when the orbit direction is towards the sun. The configuration of the controller is enabled by choosing the thermo-optical properties of the (exposed) SMA of the controller (or outer multi-layer-insulation (MLI) over the SMA) such that sun exposure brings the controller to the desired temperature band to induce the transition. The opposite transition may also be used when the spacecraft is moving away from the sun. Exemplary embodiments therefore provide a passively articulating de-orbiter (PPAD).

Exemplary embodiments of the controller may be used with a Bolt-on De-Orbit design that incorporates a one-way shape memory alloy (SMA) spring instead of a two-way SMA hinge. This design may be used with a counter non-SMA spring.

Exemplary embodiments of the controller may be used with a Bolt-on De-Orbit design that incorporates either a two-way shape memory alloy (SMA) spring or a combination of two one-way shape memory alloy (SMA) springs or a combination of a one-way shape memory allow (SMA) and a biasing element.

In an exemplary embodiment, the system may comprise a controller system having at least one one-way shape memory material spring in relation to controlling a vane of the system.

The controller system may optionally include at least one regular spring paired with the at least one, one-way shape memory material spring to impose a biasing force on the one-way shape memory material spring.

In an exemplary embodiment, the controller system and/or its associated spring(s) are encased in an enclosure with the appropriate external surface coating. In an exemplary embodiment, one side of the enclosure has a high solar absorptivity and low emissivity. The reference to high and low herein is sufficient to achieve its purpose so that the enclosure gets sufficiently hot or raises its temperature by the radiation of the sun to transition the controller system according to embodiments described herein. The other side of the enclosure has a low solar absorptivity-to-emissivity ratio (a second surface reflector), such that it gets cold even under direct solar insolation. The enclosure may be fully enclosed or may provide one or more openings such as to create a barrier between the controller and/or solar radiation/energy source.

When the temperature inside the enclosure gets hot (de-orbiter is moving “towards” the sun), the one-way SMA is triggered and goes to its transformed shortened configuration. It is designed such that the spring force it exerts at this state overcomes the regular spring imposing a biasing force.

When the de-orbiter is moving away from the sun where the low alpha over epsilon backside of the enclosure is solar irradiated, the temperature drops below the transformation temperature and the one-way SMA spring loses most of its stiffness. The regular spring, through imposition of its biasing force, pulls the de-orbiter vane and repositions the vane in a desired position.

FIG. 1 illustrates exemplary embodiments of a solar sail described herein. As illustrated, the solar sail 100 may include one or more vanes 102. As shown, four vanes 102 are illustrated, but any number of vanes may be used.

The vanes of FIG. 1 are in a first position in which all of the vanes 102 are essentially in the same plane. If the solar sail is perpendicular to solar rays in this configuration, the solar sail will receive maximum propulsion from solar pressure.

One or more of the vanes may be configured to rotate about one or more axis. For example, a vane 102 may rotate about a first axis 104 that is in plane with the vane. Rotation about axis 104 would result in one corner of the vane 102 going into the page of the figure and an opposite corner of the vane 102 going out of the page of the figure. As another example, the vane 102 may rotate about a second axis 106 that is in plane with the vane and perpendicular to the first axis. Rotation of the vane 102 about the second axis 106 results in the entire vane going into or out of the page of the figure illustrated in FIG. 1. Either rotation of the vane would rotate the vane so that the vane is generally parallel to the sun's rays for minimum propulsion from solar pressure if the FIG. 1 configuration is taken as the maximum propulsion configuration.

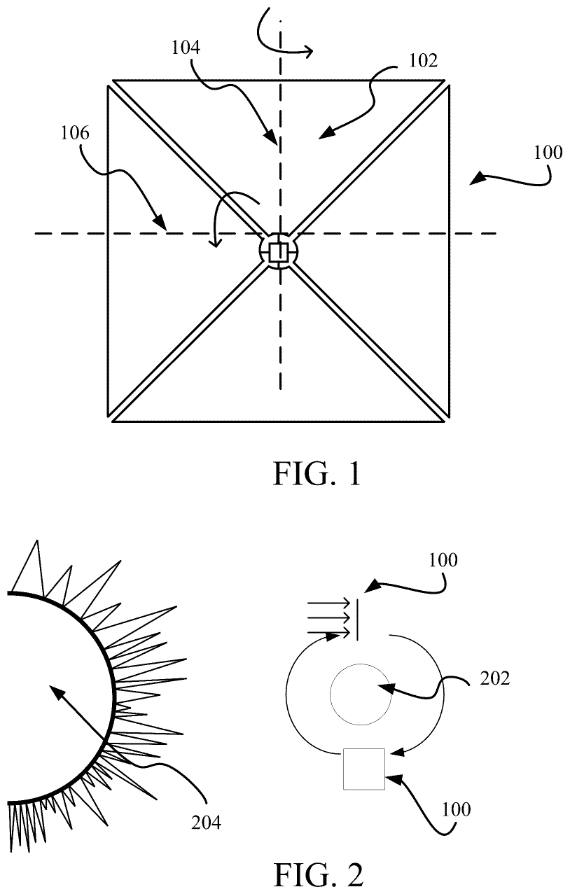

FIG. 2 illustrates an exemplary method of using the solar sail according to embodiments described herein. As illustrated, the solar sail 100 is in orbit about the Earth 202. Depending on its orientation, the sail will receive solar radiation from the sun 204 to accelerate and/or decelerate the sail. Depending on whether the solar sail is used to propel an object to maintain its orbit or move the object to a greater orbit or out of orbit or slow an object to deorbit the object, the position of the vanes can be selected to receive the solar force or not.

For example, if the solar sail is attached to an object to maintain its orbital position to the Earth, the solar sail will be used to provide propulsion to offset the deceleration observed from energy loss. In this case, as illustrated in FIG. 2, the vane should be perpendicular to the sun's rays when the sail is moving with the rays. Therefore, the vanes are deployed at the top of the image of FIG. 2 so that the sun's rays push the vane, accelerating the vane as the vane moves away from the sun. When the vane is on the opposite side of the Earth and moving toward the sun, the vanes are rotated so that the sun's rays no longer push on the vane and thereby reduce the slowing or drag on the vane created by the solar radiation. The vane therefore provides a push on part of its orbit about the Earth.

The opposite configuration is true if the object is to be slowed down and deorbited. In this case, the vane would be perpendicular to the sun's rays as the vane is moving toward the sun so that the sun's rays slow the vane down during its orbit. The vane would then turn to be generally parallel to the sun's rays when the sail is moving in the same direction as the sun's rays so that it does not get additional energy to speed it back up.

The terms parallel, perpendicular and relative alignments between components are generally referred to herein for sake of reference only. It is understood that surfaces may not be fully flat and/or that the rays of the sun are not parallel. A person of skill in the art would appreciate the general directions referenced and appreciate that deviation therefrom is understood within the scope and tolerance of the invention. Instead, the approximations are determined based on the objective of the function being achieved. For example, the vanes may move approximately 45 degrees from the fully deployed position to the retracted position. Even though 45 degrees is not parallel or perpendicular, it may be sufficient such that the difference between the solar pressure created between the two positions is sufficient to achieve the objective of maintaining a desired acceleration, deceleration, or speed of the craft to achieve the desired orbital control.

Terms for temperature are also used herein, including, for example, hot and cold. The hot and cold designations are referred to in reference to the shape memory materials in which the material is configured to be in an austenite state when the material is hot and the material is configured to be in a martensite state when it is cold. The determination of hot and cold is therefore determined based on the application and materials as would be understood by a person of skill in the art. For example, the vane illustrated in FIG. 2 is in a hot configuration and/or position when the sail is toward the sun and transitioning to the configuration so that the rays push on the vane, while the vane is in the cold configuration and/or position when the sail is away from the sun and transitions to the configuration so that the rays pass by the vane and do not substantially hinder the progress of the vane.

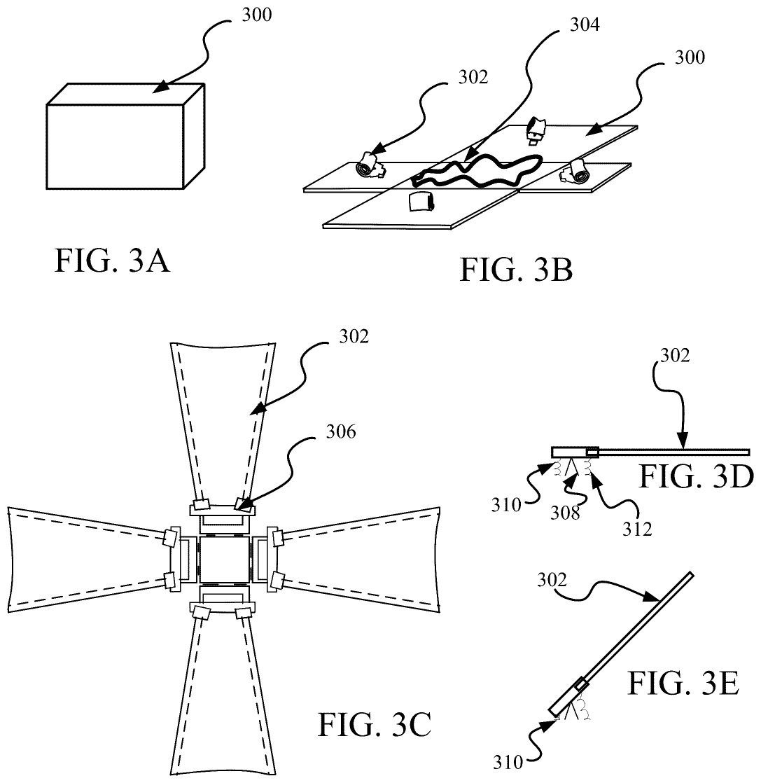

FIGS. 3A-3C illustrate exemplary configurations of the solar sail during deployment according to embodiments described herein. FIG. 3A is the solar sail in a stored configuration. FIG. 3B is the solar sail in an open configuration. FIG. 3C is the solar sail in a deployed configuration.

Referring to FIG. 3A, exemplary embodiments of the solar sail according to embodiments described herein comprises an enclosure 300. The enclosure retains the contents of the solar sail for storage. The solar sail may initially be provided in the stored configuration. The enclosure is illustrated as a rectangular compartment, but any shape may be used depending on the available payload space.

Referring to FIG. 3B, the solar sail may be deployed by opening the enclosure. As illustrated, the enclosure may be used to support one or more components parts of the sail including, for example, the vanes, and/or controllers.

As seen in FIG. 3B, the vanes 302 may be maintained in a stored configuration in which the vanes are rolled, folded, deformed or otherwise collapsed. Thereafter, as seen in FIG. 3C, the vanes can be expanded to a deployed configuration.

As seen in FIGS. 3D and 3E, the one or more controllers may thereafter be passively engaged to actuate the vanes and move to the vane from a first position to a second position.

FIGS. 3D and 3E illustrate exemplary control configurations of an individual vane according to embodiments described herein. FIG. 3D is an illustration of the control system in a first configuration and FIG. 3E is an illustration of the control system in a second configuration. Exemplary embodiments of the first configuration and second configuration may be when the solar sail is “hot”or “cold”according to embodiments described herein.

FIGS. 3D and 3E illustrate how exemplary embodiments of the control system described herein may be used to move one or more sails of the solar sail system to control an acceleration and/or deceleration of the device. Exemplary settings of the “hot” and “cold” positions may be configured such that the device is configured to accelerate the system out of orbit or decelerate the system to deorbit toward the planet.

As seen in FIG. 3D, the vane 302 is extended radially outward and generally forms a planar structure as seen in FIG. 3C. FIG. 3E is a second position in which the vane 304 is rotated out of plane from that of FIG. 3D.

In general, the control system comprises a hinge 308 so that the vane can rotate. A first controller 310 and a second controller 312 are configured to rotate the vane about the hinge 308. As illustrated, the first controller 310 and second controller 312 are both springs. The extension or compression of the spring therefore dictates the rotation of the vane about the hinge.

In an exemplary embodiment, both controllers may be shape memory structures so that they are configured to move to a defined position if a certain temperature band is obtained.

In an exemplary embodiment, one of the controllers is a shape memory structure that is configured to move to a defined position if a certain temperature band is obtained. The second controller may be a simple spring or other biasing element. The biasing element may be configured to impose a force on the system to return the vane to the desired position when the first controller is in a transition temperature band.

In an exemplary embodiment, the shape memory material may be configured to be soft and subject to deformation under an imposition of an outside force in a second temperature band, outside of the first temperature band. The shape memory material may therefore be moved or deformable when the controller is at a temperature within the second temperature band.

The second controller may be configured to impose a biasing force to act as an outside force when the shape memory material of the first controller is in the second temperature band to deform the shape memory material to a desired configuration.

In an exemplary embodiment, the first controller comprises a shape memory material. The shape memory material may be configured to transition to a preconfigured position when the shape memory material is in a first temperature band. The transition to the preconfigured position may be without regard or in spite of an imposition of an outside force.

The combination of the first controller and second controller may be configured to position the vane in a first position while the controllers are in the first temperature band and a second position while the controllers are in the second temperature band.

For example, in the first temperature band, the first controller may be configured to transition to a remembered configuration. The first controller may overcome the biasing force imposed by the second controller and position the vane in a first position. In the second temperature band, the first controller may become deformable and the biasing force of the second controller may be used to move the vane to a second position. Thereafter, if the controllers reach the first temperature again, the first controller may again, revert to the remembered configuration and overcome the biasing force imposed by the second controller to transition the vane back to the first position.

In an exemplary embodiment, the first controller comprises a spring of shape memory material. The first controller may have a preconfigured position of the shape memory material being its unstretched length, such as represented in FIG. 3E for the first controller 310. As the first controller is in an austenite state, the shape memory material of the first controller transitions to the preconfigured position, the spring contracts from its partially extended configuration of FIG. 3D, overcomes the external force of the second controller imposing a biasing force on the controller system to move the vane out of plane. As the first controller is in a martensite (soft) state, the spring of the first controller is subject to deformation and is extended by the biasing force imposed by the retraction of the second controller 312. Conventionally, heat causes the shape memory material to change from martensite state to austenite state. Exemplary embodiments of the shape memory material are configured to exert a force greater than the biasing force imposed by the second controller.

In an exemplary embodiment, the selection of the shape memory material is made to select a desired temperature range for the martensite state (deformable condition) and austenite state (pre-configured condition). Preferably, the shape memory material is selected so that the separation between the martensite and austenite states are separated for the desired space application.

As illustrated, a first controller and second controller on opposite sides of a hinge are configured and position so that the vane rotates in and out of plane from the fully deployed configuration. Additional controllers may also be added in pairs to similarly allow for additional rotational control of the vane. The vane may therefore rotate about one or more axis as illustrated in FIG. 1.

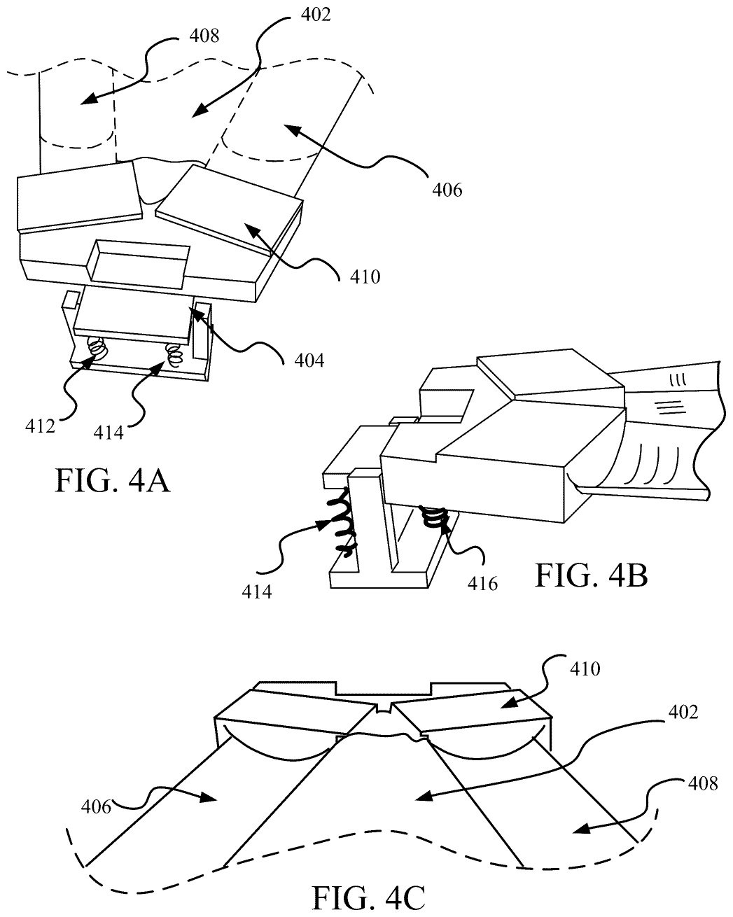

FIGS. 4A-4C illustrate exemplary blown-up component parts of exemplary features of the solar sail according to embodiments described herein. FIG. 4A is a partial component view of the control system from a first perspective. FIG. 4B is the partial component view of FIG. 4A from a second perspective. FIG. 4C is the partial component view of FIG. 4A from a third perspective.

Exemplary embodiments of the vane may include support structures 406, 408 to support the vane material 402. The vane material may be any membrane material for interfering with the solar energy. Exemplary embodiments may include other configurations beyond solar sails. In these instances, the vane material 402 may be any desirable material for the application. For example, for reflector applications, the material may be a reflective membrane.

The vane support structures 408, 406 may be any support structure for supporting the surface of the vane. The support structures may be telescoping structures, shape memory structures, deformable, foldable, or other known support structure.

In an exemplary embodiment, the support structures 406, 408 comprise tape springs. The tape spring may have a remembered configuration in an elongated or straight orientation. The tape spring may be rolled for storage. The rolled configuration may be retained as long as an outside force is maintained on the tape spring. When the outside retaining force is removed, the tape spring may passively unroll and deploy to the remembered or elongated configuration.

Exemplary embodiments of the tape spring may comprise linear elongated length. The cross section of the elongated length may define a curved surface. An example of an exemplary tape spring shape and property is a measuring tape. The tape spring can be wound to store the spring in a collapsed configuration and may be unwound to extend the spring linearly along the elongated length.

As seen in FIGS. 4A and 4C, a first support structure 406 is along a first perimeter edge of the vane 402 and a second support structure 408 is along a second perimeter edge of the vane 402. A vane material 402 is supported between the first support structure 406 and the second support structure 408.

The first support structure 406 and second support structure 408 comprise tape springs. The vane may have a stored configuration in which the tape springs are rolled and the vane is maintained in a collapsed configuration. The vane may have a deployed configuration in which the tape springs are unrolled and elongated so the vane extends radially outward and the vane material is generally planar.

Even though the vane is shown and described with support structures in the form of tape springs, the sail structure is not so limited. Any support structure may be used including, without limitation, inflatable booms, telescoping booms, shape memory composite materials, foldable or deformable arms, etc., and any combination thereof.

The vane 402 may be coupled to a mount in which one or more controllers 412, 414, 416 are used to position the vane in a desired orientation. The mount may pivotably couple the vane so that the vane may rotate about one or more axis. As illustrated in FIGS. 4A-4C, the pivot is about a single axis and is defined by rotation about a pin. Other joints are contemplated herein and may be used in place of the single axis hinge. For example, a ball joint may be used for additional degrees of freedom.

As illustrated, one or more controllers 412, 414, 416 may be used to control the orientation of the vane. As shown and described herein, at least one of the one or more controllers 412, 414, 416 comprises a shape memory material. The shape memory material may comprise a remembered shape that the controller reverts to when the material is subject to a first temperature within a given first temperature band or when the material is above or below a given first temperature. The shape memory material may comprise a flexible state where the shape memory material is flexible when the material is subject to a second temperature within a given second temperature band or when the material is below or above a given second temperature.

As shown, the control system comprises a first controller 412, a second controller 414, a third controller 416 and a pivotal connection 404 to the vane 402. The first controller 412 and second controller 414 are on a first side of the pivotal connection 404 from the third controller 416. The first controller 412 and second controller 414 will therefore move together on the same side of the pivot and the third controller 416 will work opposite from the first and second controllers.

In an exemplary embodiment, the first controller 412, second controller 414, and third controller 416 are configured as springs.

The first controller 412 and second controller 414 comprise shape memory material and the third controller 416 does not comprise a shape memory material.

In an exemplary embodiment, the shape memory material of the first controller 412 and second controller 414 comprise a remembered configuration in the compressed spring position.

In an exemplary embodiment, the shape memory material of the first controller 412 and second controller 414 is configured to return to the remembered configuration when the material is heated above a transition temperature. The spring force exerted by the first controller and second controller when returning to the remembered configuration is configured to overcome the spring force of the third controller 416 such that the first controller 412 and second controller 414 pivot the vane about the pivot connection 404 in a first rotational direction. And the spring of the third controller 416 is extended.

In an exemplary embodiment, the shape memory material of the first controller 412 and second controller 414 is configured to be deformable when the material is cooled below the transition temperature. The spring force exerted by the third controller 416 overcomes the spring force of the first controller 412 and second controller 414 such that the vane pivots about the pivot connection 404 in a second rotational direction opposite the first rotational direction.

The spring constants of the first controller, second controller, and third controller are selected to position the vane in a desired configuration and relative to the other controllers to transition the vane in the desired temperature bands to the desired positions.

Depending on when the vane is intended to move and in which position it is desired to be in when in the desired orbit, the first and second controllers may be positioned on an opposite side of the pivot from the vane or may be positioned on the same side of the pivot as the vane. The third controller may be positioned on an opposite side of the pivot from the first and second controller.

Although described herein in terms of a first and second controller and a third controller, the number of controllers is not limiting. The use of additional springs changes the imposed forces on the vane to assist in the transition in the desired temperature bands. Accordingly, the first and second controller may be combined into a single controller and have a larger spring constant than the separate controllers. Similarly, the third controller may comprise one or more separate controllers.

In an exemplary embodiment, a first controller on a first side of a pivot connection of the vane and a second controller on a second side of the pivot connection of the vane may be used to control the positioning of the vane. The first controller may include one or more controllers (such as one or more springs) and/or the second controller may include one or more controllers (such as one or more springs).

In an exemplary embodiment, the first controller may comprise a one-way shape memory material.

In an exemplary embodiment, the first controller may comprise a two-way shape memory material.

In an exemplary embodiment, the second controller may comprise a one-way shape memory material.

In an exemplary embodiment, the second controller is simple spring without a shape memory material.

As shown and described herein, a one-way shape memory material is configured to transition in one way to move to a first position when in a temperature range. When out of the temperature range, the one-way shape memory material does not automatically move to a second position but is reconfigured under an imposition of an outside force.

As shown and described herein, a two-way shape memory material is configured to transition in one way to move to a first position when in a first temperature range. When out of the temperature range or within a second temperature range, the two-way shape memory material automatically moves in a second direction to a second position without the need of an outside force.

A two-way shape memory component may be created by a combination of two, one-way shape memory components.

In an exemplary embodiment, the first controller and second controller may be positioned to rotate the vane about a first axis of rotation.

In an exemplary embodiment, additional controllers may be added to rotate the vane about a second axis of rotation. For example, a third controller may be positioned on the same side of a pivotal connection as the first controller. The first and third controller may be separately controllers such that the vane rotates about an axis perpendicular to the pivotal axis 404. Instead of the pivotal axis 404 another joint may be used such as a ball joint to permit multiple degrees of rotational freedom.

Alternatively or additionally, the additional controllers may be relative to another pivotal connection such that a first set of controllers are configured about a first pivotal axis and another, separate set of controllers are configured about a second pivotal axis such that the vane can rotate about the first pivotal axis using the first set of controllers and the vane can rotate about a second pivotal axis using the second set of controllers. Any of the first set and second set of controllers may include the features as described herein including any combination of shape memory materials and/or biasing elements, such as non-shape memory material springs.

Exemplary embodiments may enclose the one or more controllers in a temperature casing. The temperature casing may be configured to retain and/or dissipate the temperature local to the controller to facilitate the change of temperature of the shape memory material and/or permit the desired control from the shape memory within desired temperature bands.

For example, the one or more controllers may be enclosed in one or more temperature enclosures. In an exemplary embodiment, the temperature enclosure may comprise a first side having a high solar absorptivity and low emissivity. The temperature enclosure may comprise a second side, opposite the first side, having a low solar absorptivity-to-emissivity ratio.

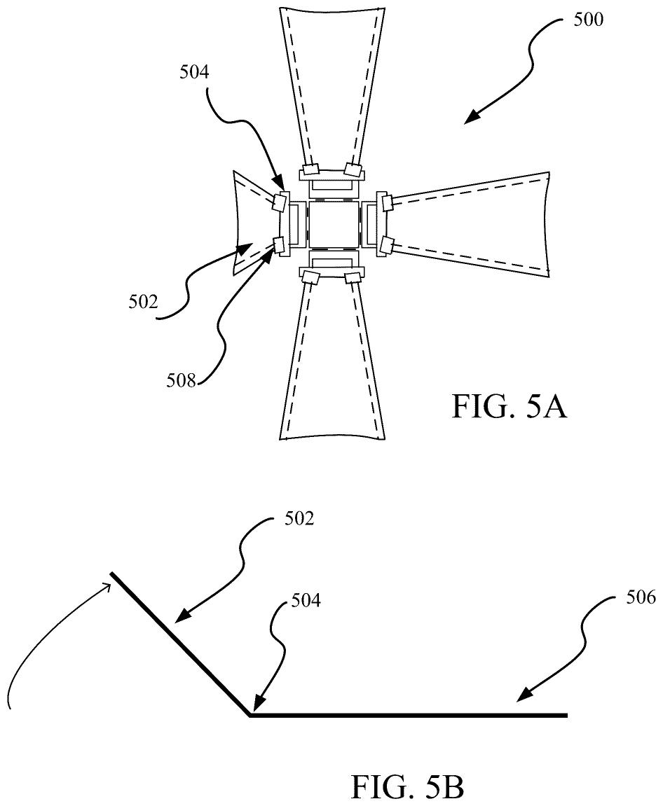

The temperature enclosure may obtain the absorptivity and/or emissivity through surface texture, surface color, material selection, coatings, or any combination thereof. FIG. 5A shows and exemplary temperature enclosure 508 about one or more controllers.

The temperature enclosure may be configured to create a partial barrier between the sun or heat source and the shape memory material so that the temperature of the shape memory material may be passively controlled. The temperature may be passively controlled by configuring the barrier to shield the controller from the sun, solar source, or heat source in a first orientation of the solar sail structure and permit the controller to receive the sun's rays, energy from a solar source or heat source in a second orientation of the solar sail structure. Sheilding the controller may lower the temperature of the controller, while not shielding and permitting access to the solar or heat energy may increase the temperature of the controller. The change in temperature of the controller may be used to passively actuate the vane associated with the controller by heating or colling the shape memory material of the controller above or below the transition temperature of the material to permit the vane to move to a biased orientation or a remembered orientation.

FIGS. 5A-5B illustrate exemplary configurations of the solar sail to illustrate the movement of the sail according to embodiments described herein. FIG. 5A illustrates the exemplary configuration from a top view. FIG. 5B illustrates the exemplary configuration from a representative side view showing orientation only and not necessarily the depth of component parts.

As illustrated in FIGS. 5A-5B, the configuration of a solar sail 500 having a first controller and second controller configured to permit rotation of a vane 502 about a first axis defined by a first pivotal connection 504.

As illustrated, when the one or more vanes 502 are deployed, they may define a first orientation in which the vanes are approximately in the same plane 506. The one or more vanes 502 may thereafter be rotated out of plane about the pivotal connection 504. In this configuration, the vane may rotate so that the vane fully rotates out of plane above or below the plane.

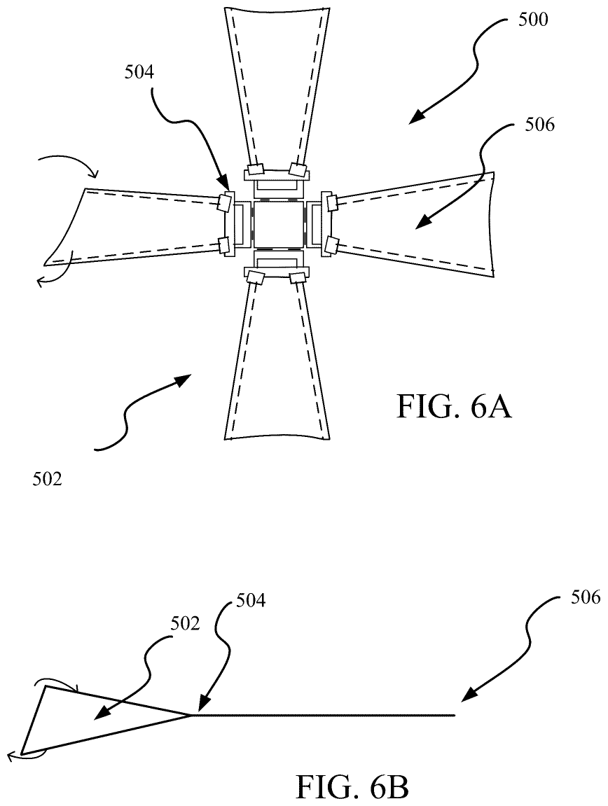

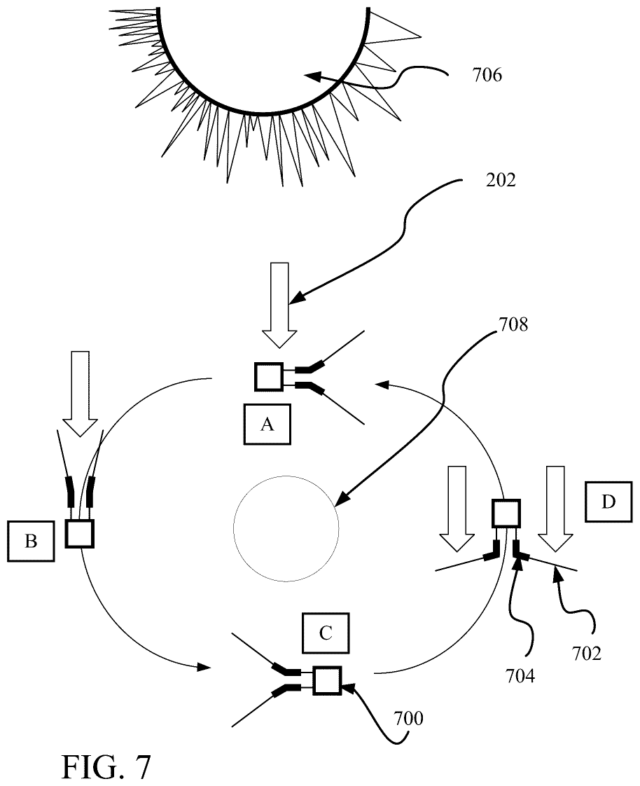

FIGS. 6A-6B illustrate exemplary configurations of the solar sail to illustrate the movement of the sail according to embodiments described herein. FIG. 6A illustrates the exemplary configuration from a top view. FIG. 6B illustrates the exemplary configuration from a representative side view showing orientation only and not necessarily the depth of component parts.

As illustrated in FIGS. 6A-6B, the configuration of a solar sail 600 having a first controller and second controller configured to permit rotation of a vane 602 about a second axis. In this configuration, the second axis is about a longitudinal length of the vane and/or may be defined as a radial axis outward from the hub of the vane.

As illustrated, when the one or more vanes 602 are deployed, they may define a first orientation in which the vanes are approximately in the same plane 606. The one or more vanes 602 may thereafter be rotated out of plane about the pivotal connection 604. In this configuration, the vane may rotate so that a portion of the vane stays in the plane but rotates above and below the plane so that the vane moves toward a perpendicular to the plane.

Exemplary embodiments of the shape memory material may also include a change in the rigidity of the material above or below a transition temperature. The shape memory material may include a static configuration at a first range of temperatures and may include a dynamic configuration at a second range of temperatures. The static configuration may be used to retain the vane's orientation set at the time the shape memory material is put within the first range of temperatures. The dynamic configuration may be used to permit the vane's orientation to be moved or transition when the shape memory material is within the second range of temperatures. The shape memory material may automatically move to a second remembered orientation and/or may be moved to a second orientation through the application of a force, such as through one or more of the biasing elements.

Although exemplary embodiments shown and described herein include controllers shaped as springs other configurations are also contemplated herein. The controllers generally comprise a shape memory material so that the position of the vane may be determined based on the remembered configuration of the controller. Other configurations beyond brings are also within the scope of the present disclosure. The spring configuration is exemplary only and not limiting.

FIG. 7 illustrates an exemplary motion of the solar sail about the earth and the movement of the vanes using the one or more controllers described herein.

At position A, an exemplary embodiment of a self-articulating de-orbiter captures solar pressure on the “dayside” of the orbit about the Earth. On this side of the orbit, the controller including a shape memory material is exposed to the sun, heating the controller to and/or above the transformation temperature. This causes the controller to articulate, leading to the vanes minimizing an area subject to the solar radiation pressure (indicated by the large arrows), see position B.

As the object continues its orbit, it will enter the terminator, where on this “nightside” of the orbit, the controller actuators are shadowed, causing the temperature to drop below the shape memory material transformation temperature, see position C. The shape memory material then shifts to its martensitic state and become “softer”, allowing the biasing element to move the controller to a second position. This results in the vanes articulating in the opposite direction, increasing the surface area of the vane subjected to solar radiation enabling a significant amount of solar radiation pressure to encounter the sail, thereby increasing absorbed solar energy on this side of the orbit, see position D. The solar energy applies energy in an opposite direction from the motion of the vane, thereby slowing the solar sail through the orbit.

The result is a net loss of orbital energy. The process continues until the object re-enters and the orbit decays.

A gravity gradient boom is employed to roughly orient the system's attitude to enhance the capture of solar energy.

Small cold gas thrusters may be added for refinement, but it is noted here that even if the normal vectors of the vanes are off by 45 degrees relative to the sun, seventy percent of solar pressure is still captured. Even a larger sixty-degree misalignment still captures fifty percent of the solar pressure.

To articulate properly at a predetermined transformation temperature, the shape memory component may be “trained.” The relative percentages of Nickel-Titanium in the Nitinol shape memory material largely determine its austenitic and martensitic properties, and thus, the transformation temperature. The transformation temperature of a shape memory material, at which the material reverts to its memorized shape and become rigid, can be tailored through proper training.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

The opposite configuration may be used to speed up the sail during the orbit in order to retain an object in orbit or to increase the orbit of the sail. In this configuration the vane extends generally perpendicular to the solar radiation at position B when the sail is moving in the same direction as the solar radiation energy.

FIG. 7 illustrates an exemplary embodiment of a solar sale 700 having two vanes 702 with controllers 704 of shape memory material according to embodiments described herein. The sale 700 orbits the Earth 708 using solar radiation from the sun 702 to accelerate or decelerate the sail during the orbit.

As shown and described herein, an exemplary solar sail is provided that has one or more vanes. Each vane has one or more controller comprising shape memory material used to automatically transition the vane from a first position to a second position. The controller is configured to transition based on the temperature of the controller based on the sail's position in its orbit.

Springs are shown and described as an exemplary configuration of the controller herein, but other configurations may also be used. For example, in FIG. 7, the controller may be a shape memory component that is configured to change shape and/or orientation from its original configuration to its remembered configuration. The controller may be configured to rotate, bend, extend, contract, or any combination thereof to achieve the orientation transition of the vane.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Conditional language used herein, such as, among others, “can,” “could,” “might,” “may,” “e.g.,” and the like, unless specifically stated otherwise, or otherwise understood within the context as used, is generally intended to convey that certain embodiments include certain features, elements and/or states. However, such language also includes embodiments in which the feature, element or state is not present as well. Thus, such conditional language is not generally intended to imply that features, elements and/or states are in any way required for one or more embodiments or that one or more embodiments necessarily exclude components not described by another embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality”refers to two or more of an item.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range.

Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

The invention claimed is:

1. An solar sail structure, comprising:
one or more vanes;
a first controller; and
a second controller, wherein the first controller and second controller are configured to rotate the vane to position the vane in a first orientation or a second orientation.

2. The solar sail structure of claim 1, wherein the first controller comprises a shape memory material.

3. The solar sail structure of claim 2, wherein the first controller comprises a first one or more springs and the second controller comprises a second one or more springs.

4. The solar sail structure of claim 3, wherein the first controller comprises a one way shape memory material.

5. The solar sail structure of claim 4, wherein the second controller is a simple spring that does not comprise a shape memory material.

6. The solar sail structure of claim 5, wherein the shape memory material comprises a remembered configuration when the shape memory material is in a transition temperature range.

7. The solar sail structure of claim 6, wherein the remembered configuration comprises a shortened spring length.

8. The solar sail structure of claim 7, further comprising a temperature enclosure around the first controller.

9. A method of passively controller a solar sail, comprising:
providing a solar sail having a controller having a shape memory material to control a position of a vane;
deploying the solar sail in an orbit;
wherein the controller is configured to transition and control a position of the vane depending on a position of the solar sail in the orbit based on a temperature experienced by the controller.

10. The method of claim 9, wherein the controller is configured to transition and control a position of the vane from a first position to a second position when the shape memory material is above a first temperature.

11. The method or claim 10, wherein the controller is configured to transition and control the position of the vane from the second position to the second position when the shape memory material is below a second temperature, below the first temperature.
